(19) United States
(12) Patent Application Publication
(10) Pub. No.: US 2007/0047649 A1
(43) Pub. Date: Mar. 1, 2007

(54) Method for coding with motion compensated prediction

(75) Inventors: Mitsuru Suzuki, Anpachi-gun (JP); Shigeyuki Okada, Ogaki-shi (JP); Hideki Yamauchi, Ogaki-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/511,439

(22) Filed: Aug. 29, 2006

(30) Foreign Application Priority Data
Aug. 30, 2005 (JP) 2005-250290

(51) Int. Cl. H04N 11/04; H04N 11/02

(52) U.S. Cl. 375/240.15; 375/240.16

(57) ABSTRACT

A motion vector search unit determines a unit area of a bidirectional prediction frame for each motion vector of a backward reference frame to pass through, and stores information on the unit area to be passed into a pass area number holding unit. A reference vector prediction unit consults the pass area number holding unit to acquire the motion vector of the backward reference frame that passes a target unit area of the bidirectional prediction frame from a motion vector holding unit, and determines a reference vector to be applied to this target unit area. The motion vector search unit applies the reference vector to the target unit area of the bidirectional prediction frame, determines a forward motion vector and a backward motion vector of the target unit area by linear prediction, and makes a motion compensated prediction on the target unit area bidirectionally to generate a predicted image.

### BACKGROUND OF THE INVENTION

1. Field of the Invention

The invention relates to a coding method for coding a moving image.

2. Description of the Related Art

With the rapid development of broadband networks, expectations are growing for services that use high quality moving images. The use of high-capacity recording media such as DVDs also contributes to increasing the number of users who enjoy high quality images. Compression coding is one of the technologies that is indispensable for transmitting moving images over communication lines and storing the same on recording media. Among the international standards for moving image compression coding technology are MPEG-4 and H.264/AVC. Furthermore, there are next-generation image compression technologies such as Scalable Video Coding (SVC), in which each single stream contains both high-quality and low-quality streams.

When streaming high-resolution moving images or storing the same on recording media, the compression rates of the moving image streams must be increased so as not to overload the communication bands and so as not to require a great deal of storing capacity. The effect of compressing moving images can be enhanced by performing motion compensated interframe predictive coding. In motion compensated interframe predictive coding, a target frame to be coded is divided into blocks, and its motion from previously-coded reference frames is predicted block by block to detect motion vectors. The motion vector information is coded along with difference images.

Japanese Patent Laid-Open Publication No. Hei 9-182083 discloses a video image coding apparatus for coding a moving image by using bidirectional motion compensation.

According to the H.264/AVC standard, motion compensation can be made in variable block sizes and in pixel resolutions as fine as ¼ pixels for more detailed prediction. This means greater amounts of coding with respect to motion vectors. With respect to the next-generation image compression technology SVC, motion compensated temporal filtering (MCTF) is under study for the sake of enhanced temporal scalability. MCTF is a technology in which time-based subband division is combined with motion compensation. This hierarchical motion compensation increases the amount of information on motion vectors significantly. As indicated above, recent technologies used for moving image compression coding tend to increase the amount of data on the entire moving image stream with an increasing amount of information on motion vectors. A technology for reducing the amount of coding ascribable to the motion vector information has thus been much sought after.

### SUMMARY OF THE INVENTION

The present invention has been achieved in view of the foregoing and other circumstances. It is therefore a general purpose of the present invention to provide a moving image coding technology which is capable of high-precision motion prediction with high coding efficiency.

To solve the foregoing and other problems, a coding method according to one of the embodiments of the present invention comprises: selecting a motion vector of a backward reference picture to be referred to when coding a target area to be coded of a picture intended for bidirectional inter-picture predictive coding, as a reference vector for use in making a linear prediction of a forward motion vector and a backward motion vector of the target area to be coded, the pictures constituting a moving image, the motion vector indicating motion to pass through the target area to be coded.

The term “picture” refers to a unit of coding such as a frame, a field, or a Video Object Plane (VOP).

According to this embodiment, it is possible to improve the precision of motion compensation and reduce the amount of coding of motion vector information.

If a plurality of motion vectors of the backward reference picture pass through the target area to be coded, at least one motion vector may be selected as the reference vector for linear prediction from among the plurality of motion vectors according to predetermined order of priority. This makes it possible to select an optimum reference vector close to the actual motion vector from among a plurality of candidate vectors, thereby decreasing the amount of difference information on pixels and reducing the amount of coding.

If a plurality of motion vectors of the backward reference picture pass through the target area to be coded, a vector determined by combining the plurality of motion vectors may be selected as the reference vector for linear prediction. This makes it possible to determine an optimum reference vector that is close to the actual motion vector by combining a plurality of candidate vectors, thereby decreasing the amount of difference information on pixels and reducing the amount of coding.

If a plurality of motion vectors of the backward reference picture pass through the target area to be coded, the number of candidate motion vectors for selection may be limited so as not to exceed a predetermined upper limit, and the reference vector for linear prediction may be selected from among the candidate motion vectors for selection, or a vector determined by combining the candidate motion vectors for selection may be selected as the reference vector for the linear prediction. The candidate motion vectors for selection may be determined according to a predetermined order of priority. When the number of candidate motion vectors for selection reaches the predetermined upper limit, it is possible to discontinue searching for motion vectors of the backward reference picture to pass through the target area to be coded. The number of candidate vectors for selection can be limited to decrease the operation for determining the reference vector for linear prediction.

If motion vectors of the backward reference picture pass through the target area to be coded and pertain to respective areas lying inside a predetermined limit area of the backward reference picture, the motion vectors in the limit area may be selected as candidate motion vectors for selection, and the reference vector for linear prediction may be selected from among the candidate motion vectors for selection. The limit area may be a predetermined number of pixels of area that can include an area of the backward reference picture lying in the same position as the target area to be coded. Since the areas to which the candidate vectors for selection pertain are limited to where it is highly possible for the actual motion vector to exist, motion vectors far different from the actual motion vector can be excluded beforehand with a reduction in the amount of operation.

If no motion vector of the backward reference picture passes through the target area to be coded, a motion vector of the backward reference picture passing near the target area to be coded may be selected as the reference vector for linear prediction. Since vectors of the backward reference picture that pass near the target area to be coded are used as candidate motion vectors for selection, it is possible to achieve the same effect as when some motion vectors pass through the target area to be coded, even if no vector passes through the target area to be coded.

It should be appreciated that any combination of the foregoing components, and any conversion of expressions of the present invention from/into methods, apparatuses, systems, recording media, computer programs, and the like are also intended to constitute applicable aspects of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a coding apparatus according to a first embodiment;

FIGS. 2A to 2C are diagrams for explaining the procedure of motion compensation in a normal direct mode;

FIGS. 3A to 3C are diagrams for explaining the problems of the normal direct mode in conjunction with specific examples;

FIG. 4 is a diagram for explaining the configuration of the motion compensation unit of FIG. 1;

FIG. 5 is a diagram for explaining the motion vectors of respective unit areas of a backward reference frame, stored in the motion vector holding unit of FIG. 4;

FIG. 6 is a diagram for explaining information on pass areas, stored in the pass area number holding unit of FIG. 4;

FIGS. 7A to 7C are diagrams for explaining the procedure by which the motion compensation unit of FIG. 4 performs motion compensation in an improved direct mode;

FIGS. 8A to 8C are diagrams for explaining the effect of the improved direct mode of FIGS. 7A to 7C in conjunction with specific examples;

FIG. 9 is a diagram for explaining the information on pass areas, stored in the pass area number holding unit according to a second embodiment;

FIG. 10 is a diagram for explaining the configuration of the motion compensation unit according to a third embodiment;

FIG. 11 is a diagram for explaining the relationship between a limit area and unit areas to which motion vectors passing through a target unit area of a bidirectional prediction frame pertain;

FIG. 12 is a block diagram of a decoding apparatus according to the first to third embodiments; and

FIG. 13 is a block diagram of the motion compensation unit of FIG. 12.

### DETAILED DESCRIPTION OF THE INVENTION

The invention will now be described by reference to the preferred embodiments. This does not intend to limit the scope of the present invention, but to exemplify the invention.

### First Embodiment

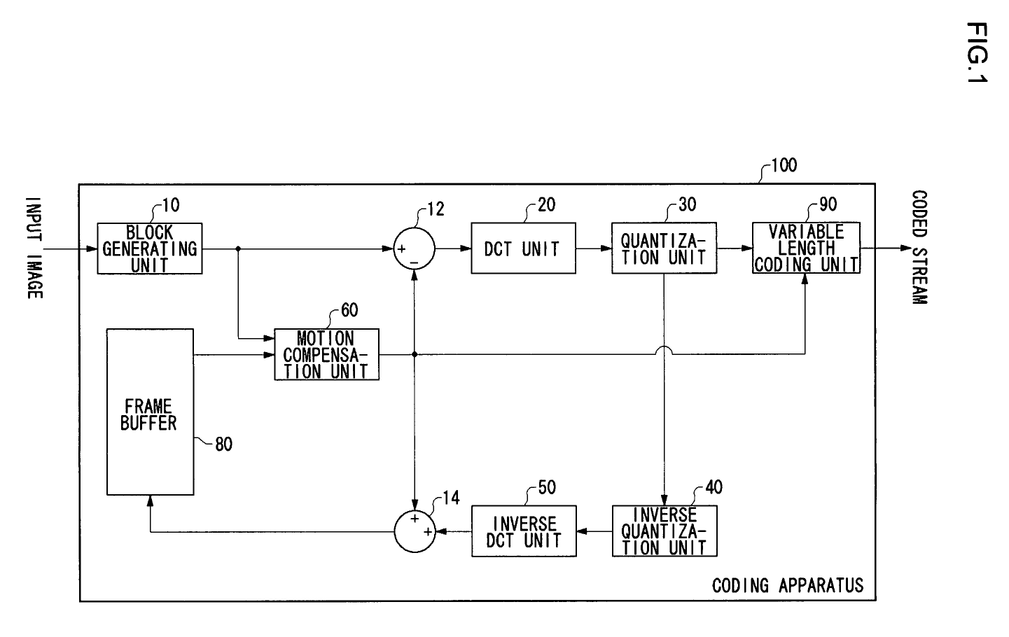

FIG. 1 is a block diagram of a coding apparatus 100 according to a first embodiment. In terms of hardware, this configuration can include an arbitrary computer CPU, a memory, and other LSIs. In terms of software, it can be achieved by a program or the like that can be loaded into a memory and can have image coding functions. The functional blocks shown in the diagram are realized by the cooperation of these hardware and software components. It should therefore be understood by those skilled in the art that these functional blocks may be practiced in various forms including hardware alone, software alone, and combinations of these forms.

The coding apparatus 100 according to the present embodiment performs moving image coding in compliance with any of the following: the MPEG (Moving Picture Experts Group) series of standards (MPEG-1, MPEG-2 and MPEG-4), standardized by the international standardization institute ISO (International Organization for Standardization)/IEC (International Electrotechnical Commission); the H.26x series of standards (H.261, H.262 and H.263), standardized by the international standardization institute for telecommunication ITU-T (International Telecommunication Union-Telecommunication Standardization Sector); and the latest moving image compression coding standard H.264/AVC, standardized by the cooperation of the two standardization institutes (the official names of the recommendation in the respective institutes are MPEG-4 Part 10: Advanced Video Coding and H.264).

According to the MPEG series of standards, image frames intended for intraframe coding are called I (Intra) frames. Image frames intended for forward interframe predictive coding, using past frames as reference images, are called P (Predictive) frames. Image frames intended for bidirectional interframe coding, using past and future frames as reference images, are called B frames.

According to H.264/AVC, in contrast, frames may be used as reference images irrespective of temporal sequence. Two past frames may be used as reference images, and two future frames as well. The number of frames available for reference images is not limited, either. Three or more frames may be used as reference images. Thus, it should be noted that while B frames in the MPEG-1/2/4 refer to Bi-directional prediction frames, B frames in H.264/AVC refer to Bi-predictive prediction frames since the temporal sequence of the reference images does not matter.

The present embodiment will deal with the case where coding is performed in units of frames, where as fields may be the units of coding. In MPEG-4, VOPs may be the units of coding.

The coding apparatus 100 receives input of a moving image frame by frame, codes the moving image, and outputs a coded stream.

A block generating unit 10 divides an input image frame into macro blocks. Macro blocks are generated from the top left to the bottom right of the image frame in succession. The block generating unit 10 supplies the generated macro blocks to a differentiator 12 and a motion compensation unit 60.

If the image frame supplied from the block generating unit 10 is an I frame, the differentiator 12 simply outputs the frame to a DCT unit 20. If the image frame is a P frame or B frame, the differentiator 12 calculates a difference from a predicted image supplied from the motion compensation unit 60, and supplies it to the DCT unit 20.

Using past or future image frames stored in a frame buffer 80 as reference images, the motion compensation unit 60 makes motion compensation on each of the macro blocks of the P or B frame input from the block generating unit 10, thereby generating motion vectors and a predicted image. The motion compensation unit 60 supplies the generated motion vectors to a variable length coding unit 90, and supplies the predicted image to the differentiator 12 and an adder 14.

The differentiator 12 determines a difference between the current image output from the block generating unit 10 and the predicted image output from the motion compensation unit 60, and outputs it to the DCT unit 20. The DCT unit 20 performs discrete cosine transform (DCT) on the difference image supplied from the differentiator 12, and supplies DCT coefficients to a quantization unit 30.

The quantization unit 30 quantizes the DCT coefficients, and supplies the resultant to the variable length coding unit 90. The variable length coding unit 90 performs variable length coding on the motion vectors supplied from the motion compensation unit 60 and the quantized DCT coefficients of the difference image as well, thereby generating a coded stream. When generating the coded stream, the variable length coding unit 90 performs processing for sorting the coded frames in time order.

The quantization unit 30 supplies the quantified DCT coefficients of the image frame to an inverse quantization unit 40. The inverse quantization unit 40 inversely quantizes the supplied quantization data, and supplies the resultant to an inverse DCT unit 50. The inverse DCT unit 50 performs inverse discrete cosine transform on the supplied inverse quantization data. This restores the coded image frame. The restored image frame is input to the adder 14.

If the image frame supplied from the inverse DCT unit 50 is an I frame, the adder 14 simply stores the image frame into a frame buffer 80. If the image frame supplied from the inverse DCT unit 50 is a P frame or B frame, i.e., a difference image, the adder 14 adds the difference image supplied from the inverse DCT unit 50 and the predicted image supplied from the motion compensation unit 60, thereby reconstructing the original image frame. The reconstructed image frame is stored into the frame buffer 80.

In the processing of coding a P or B frame, the motion compensation unit 60 performs operations as described above. In the processing of coding an I frame, on the other hand, the motion compensation unit 60 performs no operation and an intraframe prediction is performed (not shown).

When making motion compensation on a B frame, the motion compensation unit 60 operates in an improved direct mode. The standards MPEG-4 and H.264/AVC provide a direct mode for B-frame motion compensation, and an improved version of which is the improved direct mode.

For the sake of comparison, the normal direct mode will initially be described before the improved direct mode of the present embodiment.

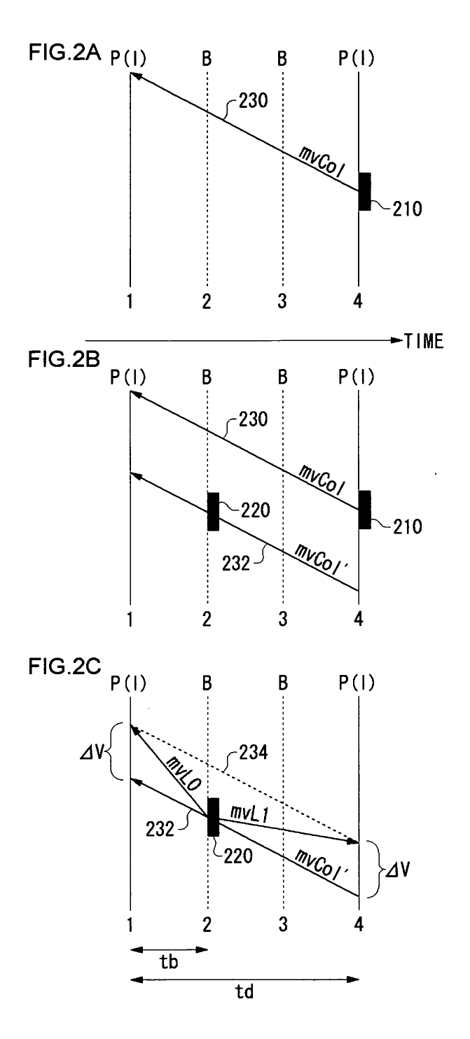

FIGS. 2A to 2C are diagrams for explaining the procedure of motion compensation in the normal direct mode. In the direct mode, one motion vector is linearly interpolated in a forward direction and a backward direction based on a linear motion model, thereby providing the effect of bidirectional prediction.

The diagrams show four frames in order of display time, with the lapse of time shown from left to right. P frame 1, B frame 2, B frame 3, and P frame 4 are displayed in this order. The frames are coded in an order that is different from the order of display. The first P frame 1 in the diagrams is initially coded. Then, the fourth P frame 4 is coded with motion compensation using the first P frame 1 as a reference image. Subsequently, the B frame 2 and the B frame 3 are each coded with motion compensation using the preceding and following two P frames 1 and 4 as reference images. It should be appreciated that the first P frame in the diagrams may be an I frame. The fourth P frame in the diagrams may also be an I frame. In this case, the motion vector of the corresponding block in the I frame is handled as (0, 0).

Suppose that the two P frames 1 and 4 are already coded, and the B frame 2 is to be coded now. This B frame 2 will be referred to as a target B frame. The P frame 4 to be displayed after the target B frame will be referred to as a backward reference P frame, and the P frame 1 to be displayed before the target B frame will be referred to as a forward reference P frame.

In bidirectional prediction mode, the target B frame 2 is predicted bidirectionally based on the two frames, i.e., the forward reference P frame 1 and the backward reference P frame 4. As a result, a forward motion vector for indicating motion with respect to the forward reference P frame 1 and a backward motion vector for indicating motion with respect to the backward reference P frame 4 are determined independently, whereby two motion vectors are generated. In the direct mode, the target B frame 2 is similarly predicted bidirectionally based on the two frames, or the forward reference P frame 1 and the backward reference P frame 4. There is a difference, however, in that both the forward and backward motion vectors are linearly predicted from a single reference motion vector.

FIG. 2A shows a motion vector mvCol 230 of a macro block 210 which is determined when coding the backward reference P frame 4.

In the direct mode, the target B frame 2 is coded on the assumption, as shown in FIG. 2B, that the motion vector mvCol 230 previously determined from the reference macro block 210 of the backward reference P frame 4, lying in the same spatial position as a target macro block 220 of the target B frame 2, is also a motion vector mvCol′ 232 of the target macro block 220 of the target macro B frame 2. The assumed motion vector mvCol′ will be referred to as a reference vector.

Next, as shown in FIG. 2C, the reference vector mvCol′ 234 is moved horizontally and vertically by ΔVx and ΔVy in parallel, respectively, thereby determining an optimum motion vector 234 so as to fit to the actual motion of the target macro block 220 in the target B frame 2. The difference vector ΔV=(ΔVx, ΔVy) indicates a difference between the moving position of the target macro block 220, linearly predicted from the reference vector mvCol′ 232, and the actual moving position of the same.

Since the reference vector mvCol′ is previously coded as the motion vector mvCol when coding the backward reference P frame 4, the vector information that needs to be coded in the direct mode is the difference vector ΔV=(ΔVx, ΔVy) alone.

The forward motion vector mvL0 and backward motion vector mvL1 of the target macro block 220 of the target B frame 2 are given by the following equations, respectively, in which the reference vector mvCol′ is internally divided at the ratio of time intervals between frames and is corrected by the difference vector ΔV:
mvL0=mvCol×tb/td+ΔV, and
mvL1=mvL0−mvCol=mvCol×(tb−td)/td+ΔV.

Here, tb is the time interval from the forward reference P frame 1 to the target B frame 2, and td is the time interval from the forward reference P frame 1 to the backward reference P frame 4.

Note that the diagrams show two-dimensional images in a one-dimensional fashion. However, the difference vector ΔV has horizontal and vertical two-dimensional components corresponding to the fact that the motion vectors have horizontal and vertical two-dimensional image components.

In the direct mode, it should also be noted that the motion vector 234 for indicating the motion from the reference position of the backward reference P frame 4, given by the backward motion vector mvL1, to the reference position in the forward reference P frame 1, given by the forward motion vector mvL0, lies in parallel with the motion vector mvCol 230 of the reference macro block 210 of the backward reference P frame 4, i.e., the reference motion vector mvCol′ 232 of the target macro block 220 of the target B frame 2. In other words, the motion vectors are unchanged in gradient.

In the direct mode, the forward motion vector mvL0 and the backward motion vector mvL1 are used to make motion compensation on the target macro block 220 and generate a predicted image.

Consider now the amounts of coding of the motion vectors. For bidirectional prediction, the forward and backward motion vectors are detected separately so that the differences from the reference images become smaller. The amount of coding of the motion vector information is higher, however, since the information on the two independent motion vectors is coded. The recent high-quality compression coding often includes motion vector search in ¼ pixel resolutions, which causes a further increase in the amount of coding of the motion vector information.

In the direct mode, on the other hand, the forward and backward motion vectors are linearly predicted by using a motion vector of the backward reference P frame 4. This eliminates the need for the coding of the motion vectors but for the information on the difference vector ΔV alone. In addition, the value of the difference vector ΔV decreases as the actual motion approaches a linear motion. If the actual motion can be approximated with a linear motion model, then the amount of coding of the difference vector ΔV is sufficiently small.

Nevertheless, as described with reference to FIG. 2B, the direct mode has the limitation that the reference vector mvCol′ 232 of the target macro block 220 of the target B frame 2 should have the same gradient as that of the motion vector mvCol 230 in the reference macro block 210 of the backward reference P frame 4 that lies in the same position as the target macro block 220 in question. Consequently, if the reference vector mvCol′ has a gradient that is far different from that of the actual motion vector of the target macro block 220, the motion prediction made between the forward reference P frame 1 and the backward reference P frame 4 by using the reference vector mvCol′ can cause a large prediction error along with an increase in the amount of coding.

The direct mode provides a high coding efficiency if the target B frame 2 and the backward reference P frame 4 are correlated with each other, and the reference vector mvCol′ of the target macro block 220 of the target B frame 2, obtained by moving the motion vector mvCol of the reference macro block 210 of the backward reference P frame 4 in parallel, is close to the actual motion vector of the target macro block 220. If not, the direct mode tends to cause a large prediction error with a drop in coding efficiency.

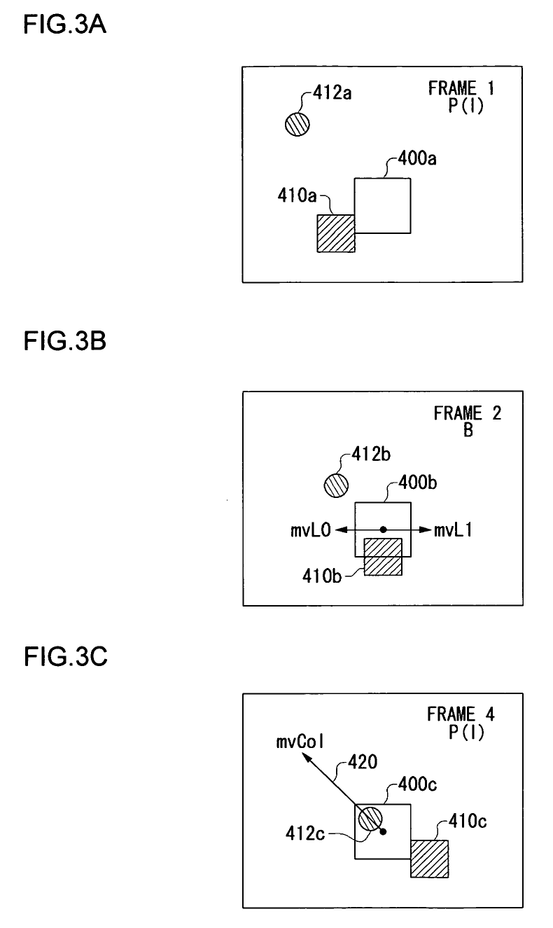

FIGS. 3A to 3C are diagrams for explaining the problems of motion compensation in the foregoing normal direct mode in conjunction with specific examples.

FIGS. 3A to 3C show the forward reference P frame 1, the target B frame 2, and the backward reference P frame 4, respectively. The area 400b shown in FIG. 3B is the target macro block of the target B frame 2. The area 400a of the forward reference P frame 1 and the area 400c of the backward reference frame 4, lying in the same position as this target macro block, are shown in FIGS. 3A and 3C, respectively.

In the forward reference P frame 1, the target B frame 2, and the backward reference P frame 4, a hatched circular object is moving from top left to bottom right as shown by the numerals 412a to 412c. In addition, a hatched square object is moving from left to right as shown by the numerals 410a to 410c.

In FIG. 3B, suppose that the actual motion of the area 400b of the target B frame 2 is indicated by the forward motion vector mvL0 and backward motion vector mvL1 which are shown horizontally. This corresponds to the forward and backward motion of the square object 410b within the area 400b of the target B frame 2.

As shown in FIG. 3C, the motion vector mvCol 420 of the area 400c of the backward reference P frame 4, corresponding to the area 400b of the target B frame 2, shows an oblique motion to the top left. This corresponds to the motion of the circular object 412c within the area 400c of the backward reference P frame 4.

In the direct mode, the motion vector mvCol of the area 400c of the backward reference P frame 4 shown in FIG. 3C is moved in parallel and used as the reference vector for the area 400b of the target B frame 2. In this example, the reference vector is oblique and the actual motion vector horizontal. Since the two vectors have significantly different gradients, a deterioration in image quality can occur and/or an increase in the amount of coding may be necessary if this reference vector is used for motion prediction.

As described above, while the direct mode is superior to bidirectional prediction mode in terms of coding efficiency, the coding efficiency can drop if the reference motion vector and the actual motion vector differ significantly from each other. Thus, the applicant has reached the understanding that there is room for improvement in at least these aspects. Hereinafter, description will be given of the “improved direct mode,” or the improved version of the direct mode.

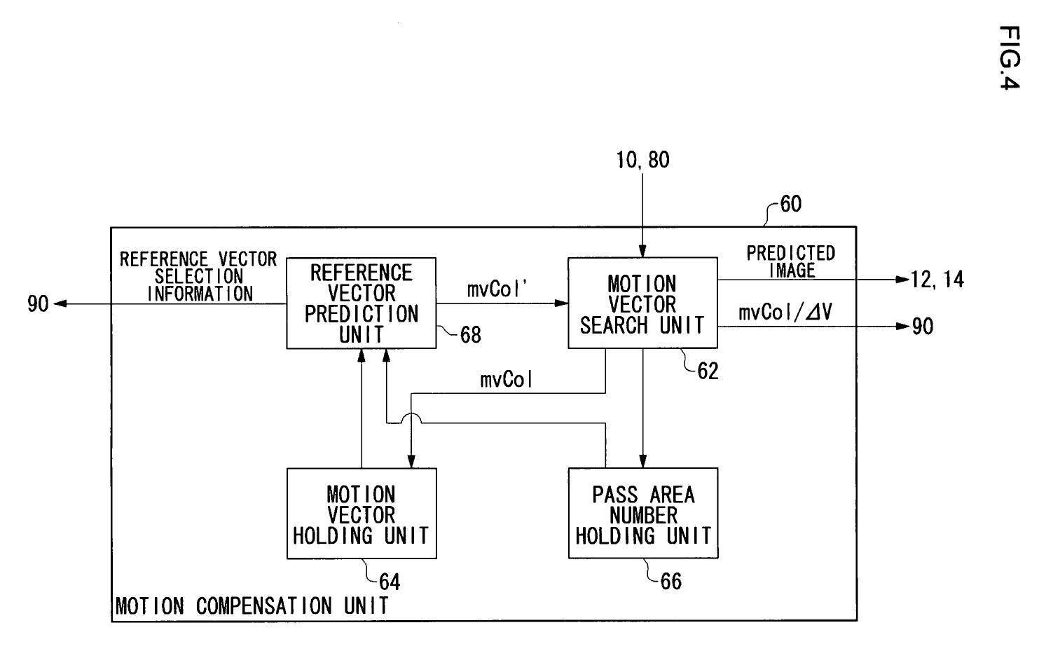

FIG. 4 is a diagram for explaining the configuration of the motion compensation unit 60.

A motion vector search unit 62 performs a motion search on a frame targeted for interframe predictive coding, thereby determining the motion vectors of respective unit areas. The motion vector search unit 62 also performs motion compensation on each of the unit areas to generate a predicted image. The motion vector search unit 62 supplies the predicted image to the differentiator 12 and the adder 14, and supplies motion vector information to the variable length coding unit 90.

The unit areas are blocks having arbitrary numbers of rows and columns of pixels. Examples of the unit areas include macro blocks and sub macro blocks.

When making a motion search on a frame to be referred to backward by a bidirectional prediction frame, the motion vector search unit 62 supplies the motion vector mvCol for each unit area to the variable length coding unit 90 and stores the same into a motion vector holding unit 64.

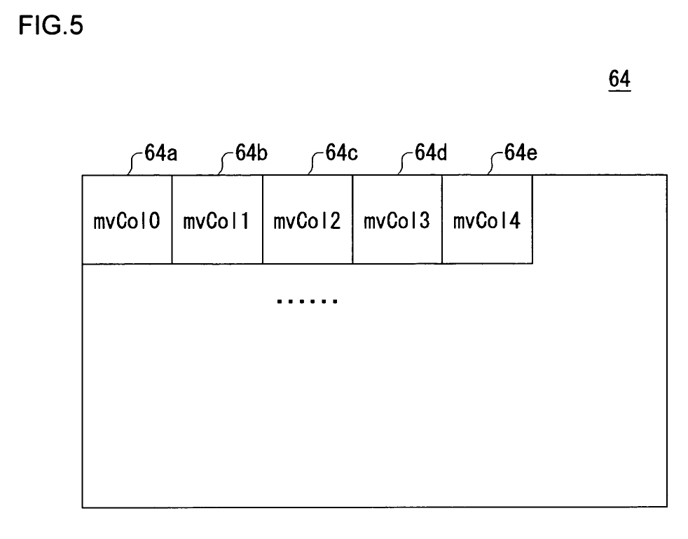

FIG. 5 is a diagram for explaining the motion vectors mvCol of respective unit areas of a backward reference frame, stored in the motion vector holding unit 64. The storing area of the motion vector holding unit 64 is divided in association with unit area numbers of the backward reference frame. The individual storing areas hold the values of the motion vectors mvCol of the corresponding unit areas. In the shown example, storing areas Nos. 0, 1, . . . , 4 (numerals 64a to 64e) corresponding to unit areas Nos. 0, 1, . . . , 4 of the backward reference frame contain the values of motion vectors mvCol0 to mvCol4 that pertain to the unit areas Nos. 0, 1, . . . , 4 of the backward reference frame.

The motion vector search unit 62 also determines which unit area of the bidirectional prediction frame the motion vector of each unit area of the backward reference frame passes, and stores information on the unit area to be passed (hereinafter, also referred to as “pass area”) into a pass area number holding unit 66.

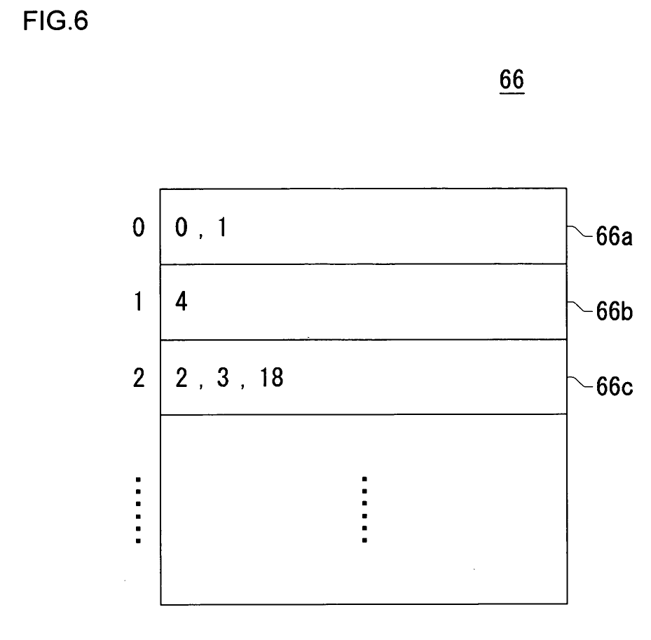

FIG. 6 is a diagram for explaining the information on pass areas, stored in the pass area number holding unit 66. The storing area of the pass area number holding unit 66 is divided in association with the unit area numbers of the bidirectional prediction frame. If any motion vector of a backward reference frame passes through a unit area of the bidirectional prediction frame, the unit area number of the backward reference frame in which the pass motion vector is defined is stored into the corresponding storing area. Hereinafter, such a motion vector of the backward reference frame is also referred to as a “pass motion vector”.

In the shown example, the storing area No. 0 (numeral 66a) contains numbers 0 and 1 of the unit areas of the backward reference frame to which the pass motion vectors passing through the unit area No. 0 of the bidirectional reference frame pertain.

Similarly, the storing area No. 1 (numeral 66b) contains number 4 of the unit area of the backward reference frame to which the pass motion vector passing through the unit area No. 1 of the bidirectional reference frame pertains. The storing area No. 2 (numeral 66c) contains numbers 2, 3, and 18 of the unit areas of the backward reference frame to which the pass motion vectors passing through the unit area No. 2 of the bidirectional reference frame pertain.

When determining the motion vectors of the respective unit areas of the backward reference frame, the motion vector search unit 62 determines the unit areas of the bidirectional reference frame for the respective motion vectors to pass through, and stores the unit area numbers of the backward reference frame into the storing areas of the pass area number holding unit 66 corresponding to the unit areas to be passed.

For example, if the motion vector search unit 62 determines that the motion vector of the unit area No. 0 of the backward reference frame passes through the unit area No. 0 of the bidirectional reference frame, it stores number 0 of the unit area of the backward reference frame into the storing area No. 0 corresponding to the unit area No. 0 to be passed.

Similarly, suppose that the motion vectors of the unit areas Nos. 1, 2, 3, 4, and 18 of the backward reference frame pass through the unit areas Nos. 0, 2, 2, 1, and 2 of the bidirectional prediction frame, respectively. Then, the motion vector search unit 62 makes the following operation: stores number 1 of the unit area of the backward reference frame further into the storing area No. 0 corresponding to the unit area No. 0 of the bidirectional prediction frame; stores number 4 of the unit area of the backward reference frame into the storing area No. 1 corresponding to the unit area No. 1 of the bidirectional prediction frame; and stores numbers 2, 3, and 18 of the unit areas of the backward reference frame into the storing area No. 2 corresponding to the unit area No. 2 of the bidirectional prediction frame.

This consequently creates the table shown in FIG. 6, in which the unit area numbers of the bidirectional prediction frame are associated with lists of unit area numbers of the backward reference frame to which the motion vectors passing through the respective unit areas pertain. If the backward reference frame is referred to from a plurality of bidirectional prediction frames, this table is created for each of the bidirectional prediction frames.

Returning to FIG. 4, description will be given of the operation when the motion vector search unit 62 makes a motion search on a bidirectional prediction frame.

When determining the motion vector of a certain target unit area of a bidirectional prediction frame, a reference vector prediction unit 68 reads, from the pass area number holding unit 66, the number(s) of the unit area(s) of the backward reference frame to which the motion vector(s) of the backward reference frame that pass(es) through the target unit area pertain(s). Next, based on the read unit area number(s) of the backward reference frame, the reference vector prediction unit 68 reads, from the motion vector holding unit 64, the value(s) of the motion vector(s) of the backward reference frame that pass(es) through the target unit area of the bidirectional prediction frame.

In the case of FIGS. 5 and 6, the reference vector prediction unit 68 reads numbers 0 and 1 from the pass area number holding unit 6 as the unit area numbers of the backward reference frame to which the pass motion vectors passing through the target unit area No. 0 of the bidirectional prediction frame pertain. Next, based on the read numbers 0 and 1 of the unit areas of the backward reference frame, the reference vector prediction unit 68 reads the values of the motion vectors mvCol0 and mvCol1 from the motion vector holding unit 64 as pass motion vectors.

The reference vector prediction unit 68 refers to the pass motion vector(s) read from the motion vector holding unit 64, determines a reference vector mvCol′ to be applied to the target unit area of the bidirectional prediction frame, and supplies it to the motion vector search unit 62.

If a plurality of pass motion vectors pass through the target unit area of the bidirectional prediction frame, the reference vector prediction unit 68 may select any one of the pass motion vectors as the reference vector, or select and combine some or all of them for use. Moreover, when a plurality of pass motion vectors pass through the target unit area, the reference vector prediction unit 68 supplies reference vector selection information to the variable length coding unit 90 so that the variable length coding unit 90 codes the information, if necessary. The reference vector selection information includes information regarding which of the motion vector is selected as the reference vector and in what order of priority the reference vector is selected from among the plurality of pass motion vectors.

The motion vector search unit 62 applies the reference vector supplied from the reference vector prediction unit 68 to the target unit area of the bidirectional prediction frame, and optimizes it with the difference vector ΔV so as to fit to the actual motion. The motion vector search unit 62 makes a linear prediction based on the reference vector that is optimized with the difference vector ΔV, thereby determining the forward motion vector mvL0 and backward motion vector mvL1 of the target unit area. The motion vector search unit 62 makes a motion compensated prediction on the target unit area bidirectionally by using the determined forward motion vector mvL0 and backward motion vector mvL1, thereby generating a predicted image. The motion vector search unit 62 supplies the predicted image to the differentiator 12 and the adder 14, and supplies the difference vector ΔV to the variable length coding unit 90 as motion vector information.

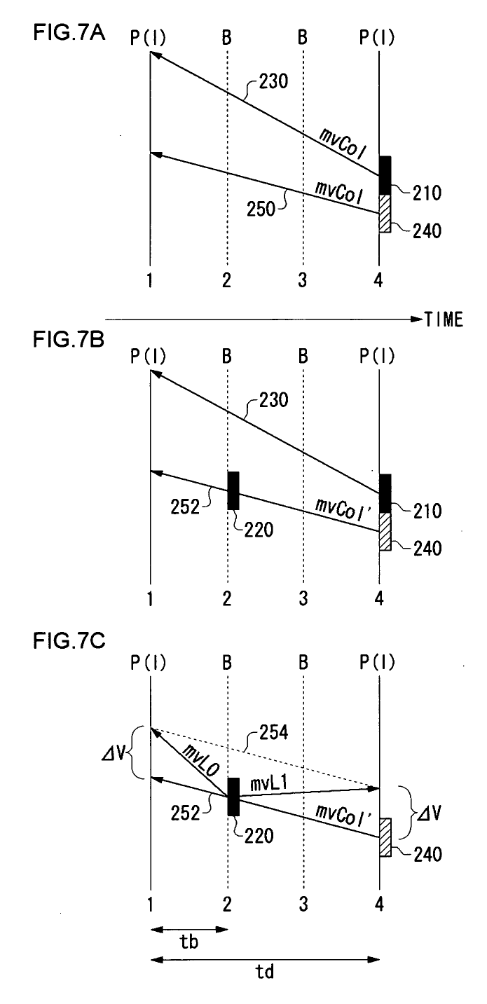

FIGS. 7A to 7C are diagrams for explaining the procedure by which the motion compensation unit 60 performs motion compensation in the improved direct mode. FIGS. 7A to 7C depict the motion compensation in the improved direct mode using the same numerals as in FIGS. 2A to 2C which explain the motion compensation in the normal direct mode. Description will be omitted where common to FIGS. 2A to 2C.

When coding the backward reference P frame 4, the motion vector search unit 62 determines the motion vectors of the respective macro blocks of the backward reference P frame 4 as shown in FIG. 7A, and stores them into the motion vector holding unit 64. Here, FIG. 7A shows the motion vector mvCol 230 of the first macro block 210 of the backward reference P frame 4 and the motion vector mvCol 250 of the second macro block 240 of the same.

When coding the target B frame 2, as shown in FIG. 7B, the reference vector prediction unit 68 selects the motion vector that passes a target macro block 220 of the target B frame 2 as the reference motion vector mvCol′ 252 of this target macro block 220 from among the motion vectors of the respective macro blocks of the backward reference P frame 4 stored in the motion vector holding unit 64.

The motion vector mvCol 230 of the first macro block 210 in FIG. 7A is not selected as the reference motion vector since it does not pass through the target macro block 220 of the target B frame 2. Meanwhile, the motion vector mvCol 250 of the second macro block 240 in FIG. 7A makes a candidate for the reference motion vector since it passes through the target macro block 220 of the target B frame 2.

In general, a plurality of motion vectors of the backward reference P frame 4 may pass through the target macro block 220 of the target B frame 2. Given only a single motion vector to pass, however, FIG. 7B shows the case where the motion vector mvCol 250 of the second macro block 240 in FIG. 7A is simply selected as the reference vector mvCol′ 252 of the target macro block 220.

Next, as shown in FIG. 7C, the motion vector search unit 62 moves the reference vector mvCol′ 252 horizontally and vertically by ΔVx and ΔVy in parallel, respectively, thereby determining an optimum motion vector 254 so as to fit to the actual motion of the target macro block 220 of the target B frame 2. The difference vector ΔV=(ΔVx, ΔVy) indicates a difference between the moving position of the target macro block 220, linearly predicted from the reference vector mvCol′ 252, and the actual moving position of the same.

The motion vector search unit 62 determines the forward motion vector mvL0 and backward motion vector mvL1 of the target macro block 220 of the target B frame 2 by the following equations, respectively, in which the reference vector mvCol′ is internally divided at the ratio of time intervals between frames and is corrected with the difference vector ΔV:
mvL0=mvCol×tb/td+ΔV, and
mvL1=mvL0−mvCol=mvCol×(tb−td)/td+ΔV.

The motion vector search unit 62 makes a motion compensation on the target macro block 220 by using the determined forward motion vector mvL0 and backward motion vector mvL1, thereby generating a predicted image.

As described in conjunction with FIG. 7B, the motion vector of the backward reference P frame 4 that passes through the target macro block 220 of the target B frame 2 is selected as the reference vector mvCol′ 252 of the target macro block 220 of the target B frame 2. It is therefore highly possible for the reference vector mvCol′ to be close to the actual motion vector of the target macro block 220. Consequently, the prediction error decreases and the coding efficiency improves if this reference vector mvCol′ is used to make a motion prediction between the forward reference P frame 1 and the backward reference P frame 4.

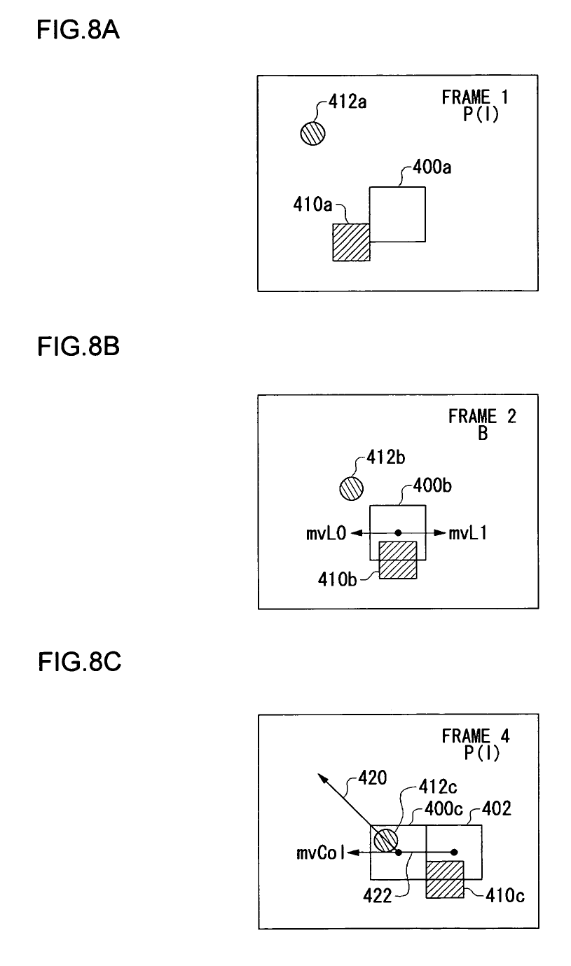

FIGS. 8A to 8C are diagrams for explaining the effect of the motion compensation in the foregoing improved direct mode in conjunction with specific examples. FIGS. 8A to 8C depict the motion compensation in the improved direct mode by using the same numerals as in FIGS. 3A to 3C. Description will be omitted where common to FIGS. 3A to 3C.

In FIG. 8B, suppose that the actual motion of an area 400b of the target B frame 2 is indicated by the forward motion vector mvL0 and the backward motion vector mvL1 which are shown horizontal in the diagram, in response to the forward and backward motion of a square object 410b located in this area 400b.

FIG. 8C shows the motion vector of an area 400c of the backward reference P frame 4 that lies in the same position as the area 400b of the target B frame 2, and the motion vector of an adjacent area 402. The area 400c of the backward reference P frame 4, that lies in the same position as the area 400b of the target B frame 2, has a motion vector (numeral 420) which indicates oblique motion toward the top left in response to the motion of a circular object 412c located in this area 400c. Meanwhile, the motion vector mvCol 422 of the adjacent area 402 of the backward reference P frame 4 indicates horizontal motion in response to the motion of a square object 410c located in this adjacent area 402. This motion vector mvCol passes through the area 400b of the target B frame 2.

In the improved direct mode, a motion vector that passes through the area 400b of the target B frame 2 is selected as the reference vector. Then, the motion vector mvCol of the adjacent area 402 of the backward reference P frame 4 shown in FIG. 8C is moved in parallel and used as the reference vector of the area 400b of the target B frame 2. In this example, the reference vector is horizontal and the actual motion vector is also horizontal. Since the two vectors have the same gradient, the reference vector can be used to make a motion prediction with a smaller prediction error for a reduced amount of coding.

### Second Embodiment

The second embodiment differs from the first embodiment in that the motion compensation unit 60 of the coding unit 100 has different configuration and makes different operation in part. As in the first embodiment, the motion vector search unit 62 of the motion compensation unit 60 according to the second embodiment determines the unit areas of a bidirectional prediction frame for the motion vectors of the respective unit areas of a backward reference frame to pass through (hereinafter, also referred to as “pass areas”), and stores information on the pass areas into the pass area number holding unit 66. A difference consists, however, in the format with which the information on the pass areas is stored into the pass area number holding unit 66. The motion vector search unit 62 and the reference vector prediction unit 68 make different operation accordingly. Description will be omitted of the same configuration and operation as in the first embodiment, but the different configuration and operation alone.

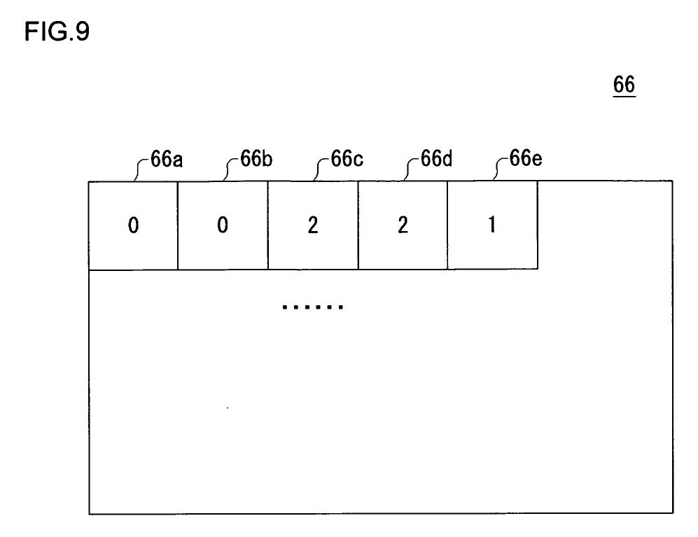

FIG. 9 depicts the information on pass areas, stored in the pass area number holding unit 66 according to the second embodiment.

The storing area of the pass area number holding unit 66 is divided in association with the unit area numbers of the backward reference frame. The individual storing areas contain the numbers of the unit areas (“pass areas”) of the bidirectional prediction frame for the motion vectors of the backward reference frame determined in the respective corresponding unit areas to pass through.

In the shown example, the storing area No. 0 (numeral 66a) contains number 0 of the unit area of the bidirectional prediction frame that the motion vector pertaining to the unit area No. 0 of the backward reference frame passes through.

Similarly, the storing areas Nos. 1, 2, 3, and 4 (numerals 66b, 66c, 66d, and 66e) contain numbers 0, 2, 2, and 1 of the unit areas of the bidirectional prediction frame that the motion vectors pertaining to the unit areas Nos. 1, 2, 3, and 4 of the backward reference frame pass through, respectively.

When determining the motion vectors of the respective unit areas of the backward reference frame, the motion vector search unit 62 determines the unit areas of the bidirectional prediction frame for the respective motion vectors to pass through, and stores the numbers of the unit areas to be passed into the storing areas of the pass area number holding unit 66 corresponding to the unit areas of the backward reference frame.

For example, if the motion vector search unit 62 determines that the motion vector of the unit area No. 0 of the backward reference frame passes through the unit area No. 0 of the bidirectional prediction frame, it stores number 0 of the unit area to be passed into the storing area No. 0 corresponding to the unit area No. 0 of the backward reference frame.

Similarly, if the motion vectors of the unit areas Nos. 1, 2, 3, and 4 of the backward reference frame pass through the unit areas Nos. 0, 2, 2, and 1 of the bidirectional prediction frame, the motion vector search unit 62 stores numbers 0, 2, 2, and 1 of the unit area to be passed into the storing areas Nos. 1, 2, 3, and 4 corresponding to the unit areas Nos. 1, 2, 3, and 4 of the backward reference frame, respectively.

This consequently creates the table shown in FIG. 9, in which the unit area number of the backward reference frame is associated with the number of the unit area of the bidirectional prediction frame which the motion vector of the unit area of the backward reference frame passes through. If the backward reference frame is referred to from a plurality of bidirectional prediction frames, this table is created for each of the bidirectional prediction frames.

When determining the motion vector of a certain target unit area of the bidirectional prediction frame, the reference vector prediction unit 68 searches the information on pass areas held in the pass area number holding unit 66, and acquires the number(s) of the unit area(s) of the backward reference frame to which the motion vector(s) of the backward reference frame that pass(es) through the target unit area pertain(s).

Suppose, in the example of FIG. 9, that the number of the target unit area is 2. The reference vector prediction unit 68 searches the pass area number holding unit 66 and, based on numbers 2 and 3 of the storing areas that contain a value of 2, acquires numbers 2 and 3 of the unit areas of the backward reference frame to which the motion vectors that pass through the target unit area No. 2 pertain.

Next, based on the acquired unit area number(s) of the backward reference frame, the reference vector prediction unit 68 reads, from the motion vector holding unit 64, the value(s) of the motion vector(s) of the backward reference frame that pass(es) through the target unit area of the bidirectional prediction frame.

In the example of FIG. 5, the reference vector prediction unit 68 reads the values of the motion vectors mvCol2 and mvCol3 of the acquired unit area numbers 2 and 3 of the backward reference frame from the motion vector holding unit 64 as pass motion vectors.

The subsequent operation is the same as in the first embodiment.

### Third Embodiment

The third embodiment differs from the first embodiment in that the motion compensation unit 60 of the coding unit 100 has different configuration and makes different operation in part. In the third embodiment, the motion compensation unit 60 is not provided with the pass area number holding unit 66. The motion vector search unit 62 and the reference vector prediction unit 68 make different operation accordingly. Description will be omitted of the same configuration and operation as in the first embodiment, but the different configuration and operation alone.

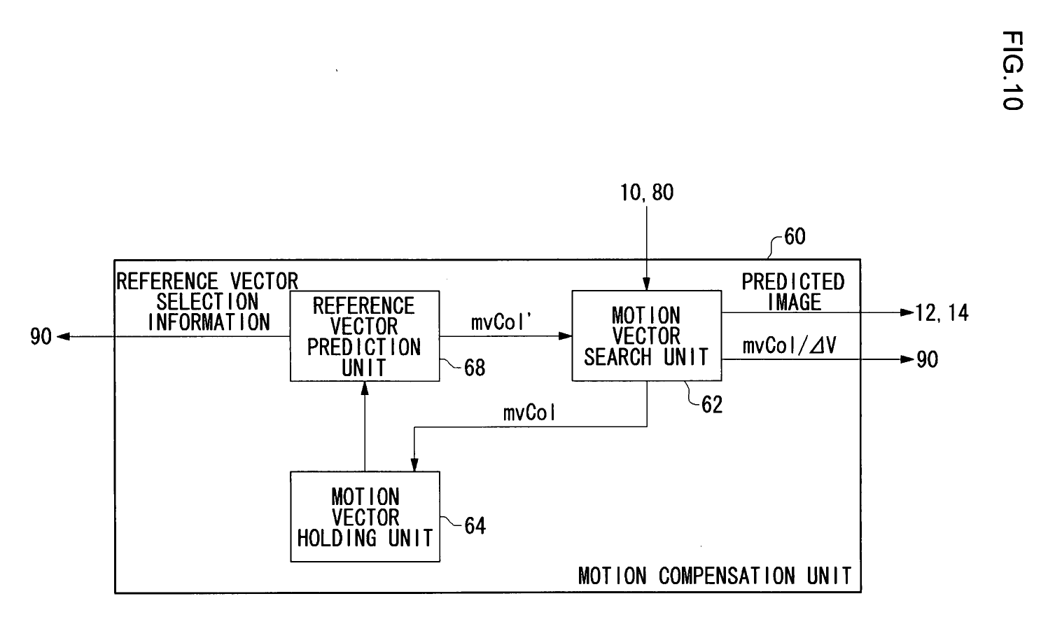

FIG. 10 is a diagram for explaining the configuration of the motion compensation unit 60 according to the third embodiment. Unlike in the first embodiment, the motion compensation unit 60 does not contain the pass area number holding unit 66. The motion vector search unit 62 determines the motion vectors of the respective unit areas of a backward reference frame, and stores them into the motion vector holding unit 64. Nevertheless, unlike in the first embodiment, the motion compensation unit 60 will not make the operation of determining which unit areas of a bidirectional prediction frame for the determined motion vectors to pass through. The motion vector holding unit 64 has the same configuration as in the first embodiment.

The reference vector prediction unit 68 reads the values of the motion vectors of the respective unit areas of the backward reference frame from the motion vector holding unit 64, and determines the unit areas of the bidirectional prediction frame for the respective motion vectors to pass through. Next, when determining the motion vector of a certain target unit area of the bidirectional prediction frame, the reference vector prediction unit 68 uses the foregoing results to identify the motion vector(s) of the backward reference frame that pass(es) through the target unit area. The subsequent operation is the same as in the first embodiment.

According to this configuration, when coding a bidirectional prediction frame, the reference vector prediction unit 68 determines the unit areas of the bidirectional prediction frame for the motion vectors of a backward reference frame to pass through. Consequently, when the motion vector search unit 62 codes the backward reference frame, it need not determine the unit areas of the bidirectional prediction frame for the motion vectors of the backward reference frame to pass through. This also eliminates the need for a memory for storing information on the unit areas of the bidirectional prediction frame to be passed. Therefore, the configuration is particularly effective when the memory capacity available for the motion compensation unit 60 is limited.

Hereinafter, detailed description will be given of the criteria for selecting a reference vector when a plurality of motion vectors of a backward reference frame pass a target unit area of a bidirectional prediction frame to be coded. The following description shall apply to any of the coding apparatuses 100 according to the first to third embodiments.

When a plurality of motion vectors of a backward reference frame pass a target unit area of a bidirectional prediction frame, the reference vector prediction unit 68 may determine if the unit areas to which the respective pass motion vectors pertain fall within a predetermined limit area. Then, a pass motion vector located in the limit area may be selected as a candidate for the reference vector.

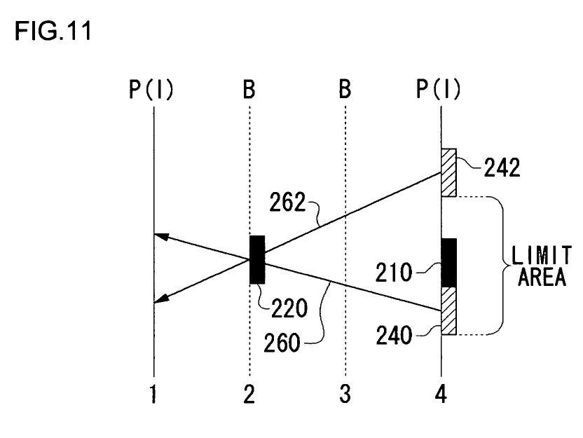

FIG. 11 is a diagram for explaining the relationship between the limit area and the unit areas to which pass motion vectors pertain. A predetermined pixel width of area is set as the limit area astride the macro block 210 of the backward reference P frame 4 that lies in the same position as the target macro block 220 of the B frame 2.

The first macro block 240 and the second macro block 242 of the backward reference P frame 4 have motion vectors (numerals 260 and 262), respectively, that pass through the target macro block 220. The first macro block 240 is located inside the limit area, while the second macro block 242 is located outside the limit area. In this case, the motion vector (numeral 260) of the first macro block 240 located in the limit area is a candidate for the reference vector, while the motion vector (numeral 262) of the second macro block 242 located outside the limit area is not.

If there are a plurality of pass motion vectors that pass through the target unit area of the bidirectional prediction frame, the reference vector prediction unit 68 may select any one of the pass motion vectors as the reference vector. Some or all of them may be selected and combined into a reference vector. Selecting from among a plurality of pass motion vectors or combining a plurality of mass motion vectors can improve the accuracies of reference vectors so that a predicted image is created with smaller prediction errors. This can further reduce the amount of coding as to difference images, thereby improving the coding efficiency.

The reference vector prediction unit 68 may select a reference vector from among a plurality of pass motion vectors according to the order of priority based on the following criteria. Any one of the following criteria may be used by itself, or a plurality of them may be used in combination.

The plurality of pass motion vectors that pass through the target unit area of the bidirectional prediction frame may be prioritized with reference to the distances between the center of the target unit area and the positions where the respective pass motion vectors pass. The shorter the distance, i.e., the closer point to the target unit area a pass motion vector passes, the higher priority the motion vector is selected as the reference vector with.

Priority may be given in order of closeness to an average of the plurality of pass motion vectors. The closer to average motion a pass motion vector, the higher priority it is selected as the reference vector with. Instead of the average, a median or a mode may be used as the criterion. The average may otherwise be determined from the maximum and minimum values out of the plurality of pass motion vectors.

The plurality of pass motion vectors may be prioritized based on their magnitudes. For example, higher priority is given to pass motion vectors having smaller magnitudes. The smaller amount of motion a pass motion vector makes, the higher priority it is selected as the reference vector with.

The order of priority may be determined based on the magnitudes of coded motion vectors in adjacent unit areas around the target unit area of the bidirectional prediction frame. The adjacent unit areas refer to the unit areas adjoining immediately on the top, bottom, right, left, top right, top left, bottom right, and bottom left. If there are a plurality of coded motion vectors, one of them may be selected. Otherwise, some of the coded motion vectors may be selected, and prioritized based on an average, median, or mode thereof, or an average of the maximum and minimum values thereof.

The plurality of pass motion vectors that pass through the target unit area of the bidirectional prediction frame may be prioritized in order of closeness to the value of a motion vector of the backward reference frame that lies in the same position as the target unit area. Otherwise, higher priority may be given in order of closeness to the value of a motion vector of the forward reference frame that lies in the same position as the target unit area.

The plurality of pass motion vectors may be prioritized in order of closeness to the value of a global motion vector in any one of the frame to be coded, the backward reference frame, and the forward reference frame.

A reference vector of the target unit area of the bidirectional prediction frame may be determined from motion vector information as to the entire frame, acquired from an external component of the coding apparatus 100 such as the signal processing unit of a digital video camera. Then, the plurality of pass motion vectors may be prioritized in order of closeness to the reference value. For example, when the entire screen makes such a motion as a pan, tilt, and zooming, it is possible to express the motion of the entire screen in affine transformation parameters or the like. Then, based on these parameters, the vector of the target unit area can be determined and used as the reference value.

With the foregoing criteria, the “distance” may be the sum of horizontal and vertical distances. In other words, the distance may be a linear distance determined from the sum of the squares of horizontal and vertical distances or the like. If the motion vectors are prioritized in order of their magnitude, a difference between the magnitudes of the motion vectors may be determined from the sum of horizontal and vertical differences or from the sum of the squares of horizontal and vertical differences.

When a plurality of pass motion vectors are selected and combined into a reference vector, the pass motion vectors selected may be averaged to create the reference vector. The pass motion vectors selected may be averaged with weights to create the reference vector. In the case of the weighted average, the weights may be determined by using any one of the indexes that are used to prioritize the foregoing plurality of pass motion vectors. The weights may be determined by using some of the indexes in combination.

Given a plurality of pass motion vectors, it is possible to select arbitrary one from among the plurality of pass motion vectors and code the selection information for indicating which of the motion vectors is selected. The selection information may be the position number of the unit area of the backward reference frame to which the motion vector selected as the reference vector pertains. It may also be the number of priority used for selection.

Selection from among a plurality of pass motion vectors may be made systematically depending on the order of priority described in conjunction with the above criteria. As long as the reference vector is selected systematically, it is possible for the decoding side to identify the motion vector selected as the reference vector if the rule is known. This can eliminate the need to code the selection information indicating which pass motion vector is selected, thereby allowing a reduction in the amount of coding.

If there are a plurality of pass motion vectors that pass through the target unit area of the bidirectional prediction frame, the number of candidates for selection, i.e., pass motion vectors may be limited. When limiting the number of candidates, the candidate pass motion vectors may be prioritized in various ways. For example, higher priority may be given to pass motion vectors if the unit areas of the backward reference frame to which the respective pass motion vectors pertain are closer to the position of the target unit area of the bidirectional prediction frame. Higher priority may also be given to pass motion vectors having smaller magnitudes, or pass motion vectors that pass points closer to the center of the target unit area. The number of candidates can be limited to reduce the capacity of the pass area number holding unit 66 of the first embodiment.

If no motion vector passes through the target unit area of the bidirectional prediction frame, the reference vector may be determined by any of the following methods.

A motion vector that passes closest to the target unit area may be selected as the reference vector. A motion vector in the unit area of the forward reference frame or backward reference frame that lies in the same position as the target unit area may be selected as the reference vector.

Coded motion vectors in adjacent unit areas around the target unit area may be selected as the reference vector. The adjacent unit areas are defined as described previously. If there are a plurality of coded motion vectors, one of them may be selected as a reference vector. Otherwise, the reference vector may be determined based on an average, median, or mode thereof, or an average of the maximum and minimum values of the coded motion vectors.

Any one of the global motion vectors of the frame to be coded, the backward reference frame, and the forward reference frame may be selected as the reference vector. A vector of the target unit area of the bidirectional prediction frame may be determined as the reference vector based on motion vector information as to the entire frame, acquired from an external component of the coding apparatus 100 such as the signal processing unit of a digital video camera.

As described above, when coding a target unit area of the bidirectional prediction frame, the coding apparatuses 100 of the first to third embodiments select a motion vector that passes through the target unit area of the bidirectional prediction frame, out of the motion vectors of previously-coded reference frames, as the reference vector for motion compensated predictive coding. This can reduce errors between the reference vector and the actual motion vector of the target unit area, so that the amount of coding of motion vectors decreases and the efficiency of compression coding of the entire moving image improves.

At higher image resolutions, motion vectors grow in magnitude and thus the ratio of the amount of coding of the motion vector information to the entire code becomes higher. This enhances the effect of reducing the amount of coding of motion vectors by virtue of the improved direct mode according to the embodiments, with a further improvement in the coding efficiency as compared to the other coding modes.

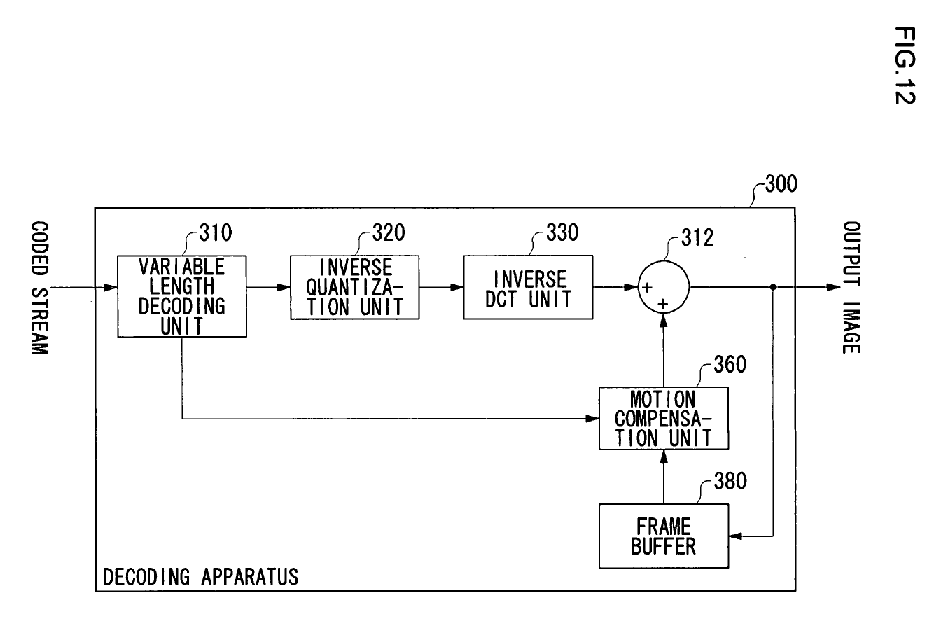

FIG. 12 is a block diagram of a decoding apparatus 300 which is common to the first to third embodiments. These functional blocks may also be achieved in various forms including hardware alone, software alone, and a combination of these forms.

The decoding apparatus 300 receives input of a coded stream that is coded by the coding apparatus 100, and decodes the coded stream to generate an output image.

A variable length decoding unit 310 performs variable decoding on the input coded stream, supplies the decoded image data to an inverse quantization unit 320, and supplies motion vector information to a motion compensation unit 360.

The inverse quantization unit 320 inversely quantizes the image data decoded by the variable length decoding unit 310, and supplies the resultant to an inverse DCT unit 330. The image data inversely quantized by the inverse quantization unit 320 includes DCT coefficients. The inverse DCT unit 330 performs inverse discrete cosine transform (IDCT) on the DCT coefficients that are inversely quantized by the inverse quantization unit 320, thereby restoring the original image data. The image data restored by the inverse DCT unit 330 is supplied to an adder 312.

If the image data supplied from the inverse DCT unit 330 is an I frame, the adder 312 simply outputs the image data of the I frame as well as stores it into a frame buffer 380 as a reference image for generating a predicted image such as a P frame and a B frame.

If the image frame supplied from the inverse DCT unit 330 is a P frame, i.e., a difference image, the adder 312 adds the difference image supplied from the inverse DCT unit 330 and the predicted image supplied from the motion compensation unit 360. The adder 14 thereby reconstructs the original image frame for output.

The motion compensation unit 360 generates a P frame or B frame, i.e., a predicted image by using the motion vector information supplied from the variable length decoding unit 310 and the reference images stored in the frame buffer 380. The generated predicted image is supplied to the adder 312. Description will now be given of the configuration and operation of the motion compensation unit 360 for decoding a B frame that has been coded in the improved direct mode.

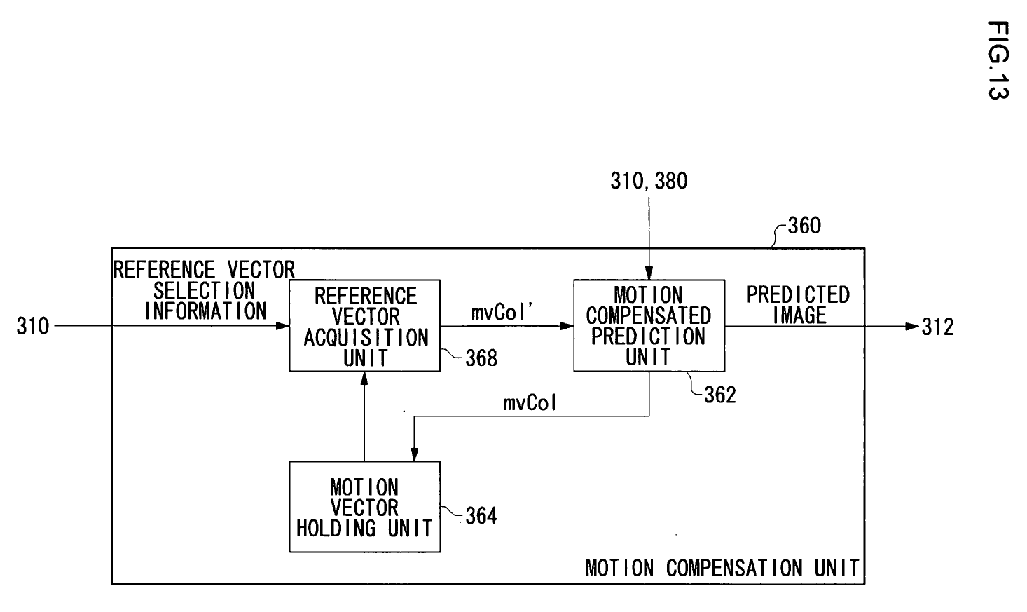

FIG. 13 is a block diagram of the motion compensation unit 360. A motion compensated prediction unit 362 makes a motion compensation on a frame that has been coded by interframe predictive coding, and supplies a predicted image to the adder 312. When making a motion compensation on a frame to be referred to backward by a bidirectional prediction frame, the motion compensated prediction unit 362 stores the motion vector mvCol of each unit area into a motion vector holding unit 364.

A reference vector acquisition unit 368 receives, from the variable length decoding unit 310, decoded reference vector selection information on a target unit area of a bidirectional prediction frame to be decoded. The reference vector acquisition unit 368 consults the reference vector selection information to acquire a reference vector mvCol′ from the motion vectors of the backward reference frame held in the motion vector holding unit 364. The reference vector selection information includes, for example, the number of the unit area to which the motion vector of the backward reference frame to be referred to as the reference vector pertains, and priority numbers if there are a plurality of motion vectors of the backward reference frame to refer to. From the motion vector(s) of the backward reference frame, it is possible to identify the reference vector to be applied to this target unit area to be decoded.

The reference vector acquisition unit 368 supplies the acquired reference vector vmCol′ to the motion compensated prediction unit 362. The motion compensated prediction unit 362 applies the reference vector supplied from the reference vector acquisition unit 368 to the target unit area of the bidirectional prediction frame to be decoded. The motion compensated prediction unit 362 then determines the forward motion vector mvL0 and backward motion vector mvL1 of the target unit area to be decoded by using a difference vector ΔV which is acquired from the variable length decoding unit 310. The motion compensated prediction unit 362 makes a motion compensation on the target unit area to be decoded by using the determined forward motion vector mvL0 and the backward motion vector mvL1, thereby generating a predicted image.

According to the decoding apparatus 300 of the first to third embodiments, when decoding a target unit area of a bidirectional prediction frame to be decoded, the decoding apparatus 300 performs motion compensation by using a motion vector that passes through the target unit area of the bidirectional prediction frame to be decoded, out of the motion vectors of previously-decoded reference frames, as the reference vector. This can reduce errors between the reference vector and the actual motion vector of the target unit area to be decoded, so that the precision of motion compensation can be improved and the high-quality moving images can be reproduced.

Up to this point, the present invention has been described in conjunction with the embodiments thereof. The embodiments have been given solely by way of illustration. It should be understood by those skilled in the art that various modifications may be made to combinations of the foregoing components and processes, and all such modifications are also intended to fall within the scope of the present invention.

The foregoing description has dealt with the improved direct mode, or an improved version of the direct mode, in which a motion compensation on a B frame is made by bidirectional prediction using P frames preceding and following in display time. The improved direct mode to be effected by the motion compensation unit 60 of the coding apparatus 100 according to the embodiments is not necessarily limited to the use of temporally-preceding and following reference images. Two past P frames or two future P frames may be used for the linear prediction so that the correction is similarly made by using two difference vectors.

The direct prediction in the improved direct mode of the present invention and conventional forward prediction, backward prediction, bidirectional prediction, and intraframe prediction may be switched in use if necessary. Optimum prediction methods can be selected frame by frame or unit area by unit area for the sake of more efficient coding.

What is claimed is:

1. A coding method comprising: selecting a motion vector of a backward reference picture to be referred to when coding a target area to be coded of a picture intended for bidirectional inter-picture predictive coding, as a reference vector for use in making a linear prediction of a forward motion vector and a backward motion vector of the target area to be coded, the pictures constituting a moving image, the motion vector indicating motion to pass through the target area to be coded.

2. The coding method according to claim 1, wherein
if a plurality of motion vectors of the backward reference picture pass through the target area to be coded, at least one motion vector is selected as the reference vector for the linear prediction from among the plurality of motion vectors according to predetermined order of priority.

3. The coding method according to claim 1, wherein
if a plurality of motion vectors of the backward reference picture pass through the target area to be coded, a vector determined by combining the plurality of motion vectors is selected as the reference vector for the linear prediction.

4. The coding method according to claim 1, wherein
if a plurality of motion vectors of the backward reference picture pass through the target area to be coded, the number of candidate motion vectors for selection is limited so as not to exceed a predetermined upper limit, and the reference vector for the linear prediction is selected from among the candidate motion vectors for selection.

5. The coding method according to claim 2, wherein
if a plurality of motion vectors of the backward reference picture pass through the target area to be coded, the number of candidate motion vectors for selection is limited so as not to exceed a predetermined upper limit, and the reference vector for the linear prediction is selected from among the candidate motion vectors for selection.

6. The coding method according to claim 3, wherein
if a plurality of motion vectors of the backward reference picture pass through the target area to be coded, the number of candidate motion vectors for selection is limited so as not to exceed a predetermined upper limit, and a vector determined by combining the candidate motion vectors for selection is selected as the reference vector for the linear prediction.

7. The coding method according to claim 1, wherein
if motion vectors of the backward reference picture pass through the target area to be coded and pertain to respective areas lying inside a predetermined limit area of the backward reference picture, the motion vectors in the limit area are selected as candidate motion vectors for selection, and the reference vector for the linear prediction is selected from among the candidate motion vectors for selection.

8. The coding method according to claim 2, wherein
if motion vectors of the backward reference picture pass through the target area to be coded and pertain to respective areas lying inside a predetermined limit area of the backward reference picture, the motion vectors in the limit area are selected as candidate motion vectors for selection, and the reference vector for the linear prediction is selected from among the candidate motion vectors for selection.

9. The coding method according to claim 3, wherein
if motion vectors of the backward reference picture pass through the target area to be coded and pertain to respective areas lying inside a predetermined limit area of the backward reference picture, the motion vectors in the limit area are selected as candidate motion vectors for selection, and a vector determined by combining the candidate motion vectors for selection is selected as the reference vector for the linear prediction.

10. The coding method according to claim 7, wherein
the limit area is a predetermined number of pixels of area that includes an area of the backward reference picture lying in the same position as the target area to be coded.

11. The coding method according to claim 8, wherein
the limit area is a predetermined number of pixels of area that includes an area of the backward reference picture lying in the same position as the target area to be coded.

12. The coding method according to claim 9, wherein
the limit area is a predetermined number of pixels of area that includes an area of the backward reference picture lying in the same position as the target area to be coded.

13. The coding method according to claim 1, wherein
if no motion vector of the backward reference picture passes through the target area to be coded, a motion vector of the backward reference picture passing near the target area to be coded is selected as the reference vector for the linear prediction.

14. The coding method according to claim 2, wherein
if no motion vector of the backward reference picture passes through the target area to be coded, a motion vector of the backward reference picture passing near the target area to be coded is selected as the reference vector for the linear prediction.

15. The coding method according to claim 3, wherein
if no motion vector of the backward reference picture passes through the target area to be coded, a motion vector of the backward reference picture passing near the target area to be coded is selected as the reference vector for the linear prediction.
